(19) United States
(12) Patent Application Publication
(10) Pub. No.: US 2015/0050635 A1
(43) Pub. Date: Feb. 19, 2015

(54) EXAMINEE EQUIPMENT, TEST MANAGING SERVER, TEST PROGRESSING METHOD OF EXAMINEE EQUIPMENT, AND TEST ANALYZING METHOD OF TEST MANAGING SERVER

(71) Applicant: Etoos Academy Co., Ltd., Seoul (KR)

(72) Inventors: Tae Wun HONG, Yongin (KR); Min KIM, Seongnam (KR); Mi Young LEE, Seoul (KR)

(73) Assignee: Etoos Academy Co., Ltd., Seoul (KR)

(21) Appl. No.: 13/965,595

(22) Filed: Aug. 13, 2013

(51) Int. Cl. G09B 7/06

(52) U.S. Cl. CPC G09B 7/06
USPC 434/353; 434/362

(57) ABSTRACT

The present invention provides an apparatus and a method for providing a practical question solving exercise and question solving habit correction using an equipment of an examinee in preparation for a multiple choice test.

### BACKGROUND OF THE INVENTION

1. Field of the Invention

The present invention relates to an apparatus and a method for providing a practical question solving exercise and a question solving habit correction using an equipment of an examinee in preparation for a multiple choice test.

2. Description of the Prior Art

A test sheet is provided in the course of performing scoring in elementary, middle, and high schools, a university entrance examination, the College Scholastic Ability Test, various certified qualification tests, a driver's license test, and the like and an Optical Mark Reader (OMR) card is used for writing answers for a multiple choice test.

Test takers, who prepare for entrance and qualification tests, need question solving practice in the same manner as an actual test in addition to learning. However, there is no way to have question solving practice in the same manner as an actual test other than mock tests intermittently provided by specific institutes.

In the mock test, only result information on the obtained scores is provided, and wrong habits and errors in solving the questions may not be recognized. For example, in the test, in addition to solving methods to correct answers, proper time distribution may be important. However, in the conventional mock test providing test sheets and using an OMR card, only the final result may be known and how much time the examinee took on each question may not be known.

### SUMMARY OF THE INVENTION

Accordingly, the present invention has been made to solve the above-mentioned problems occurring in the prior art, and an object of the present invention is to provide an apparatus and a method for providing an actual practice and a question solving habit correction practice for learners and educational institutions.

In order to accomplish this object, there is provided an examinee equipment. The examinee equipment includes an input unit that receives answers input by an examinee; a display unit that displays at least one of a test sheet generated based on test sheet setting information and an answer sheet generated based on answer sheet setting information and displays the answers input by the examinee on at least one of the test sheet or the answer sheet; a controller that measures question-specific time taken in inputting an answer for each question by the examinee with respect to each question; and a communication unit that transmits test information of the examinee including information on the answers input by the examinee and information on the question-specific time.

In accordance with another aspect of the present invention, there is provided a test managing server. The test managing server includes a communication unit that receives information on answers input by an examinee from an examinee equipment; and a test scoring unit that scores and analyzes the answer based on test information of the examinee including information on the answers input by the examinee and information on question-specific time taken in inputting an answer for each question by the examinee.

In accordance with another aspect of the present invention, there is provided a test progressing method executed in an examinee equipment. The test progressing method includes displaying at least one of a test sheet and an answer sheet; receiving and displaying answers input by the examinee; measuring question-specific time taken in inputting an answer for each question by the examinee with respect to each question; and transmitting test information of the examinee including information on the answers input by the examinee and information on the question-specific time to the test managing server.

In accordance with another aspect of the present invention, there is provided a test analyzing method executed by a test managing server. The test analyzing method includes receiving information on answers input by an examinee from an examinee equipment; and scores and analyzes the answers based on test information of the examinee including information on the answers input by the examinee and information on question-specific time taken in inputting an answer for each question by the examinee.

According to the present invention described above, an actual practice and a question solving habit correction practice are possible for learners and educational institutions.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating an example of a test system to which embodiments of the present invention are applied;

FIG. 2 is a block diagram illustrating a configuration of an examinee equipment in FIG. 1;

FIG. 3 is a diagram illustrating examples of a test sheet and an OMR answer sheet displayed on the examinee equipment according to a first embodiment of the present invention;

FIGS. 4 and 5 are diagrams illustrating examples of a method of measuring question-specific time;

FIGS. 6 and 7 are diagrams illustrating data transmitted from an examinee equipment to the test managing server;

FIG. 8 is a block diagram illustrating a configuration of a test managing server of FIG. 1;

FIGS. 9 and 10 are diagrams illustrating examples of solving pattern check screens;

FIG. 11 is a diagram illustrating an example of detailed question-specific pattern analysis;

FIG. 12 is a flowchart illustrating a method according to a first embodiment of the present invention;

FIG. 13 is a diagram illustrating an example of an application information input screen displayed on an examinee equipment according to a second embodiment;

FIG. 14 is a diagram illustrating an example of an OMR answer sheet displayed on the examinee equipment according to the second embodiment;

FIG. 15 is a diagram illustrating an example of a test result screen displayed on the examinee equipment according to the second embodiment;

FIG. 16 is a diagram illustrating an example of a scoring screen displayed on the examinee equipment according to the second embodiment; and

FIG. 17 is a flowchart illustrating a method according to the second embodiment.

### DETAILED DESCRIPTION OF THE PREFERRED EMBODIMENTS

Hereinafter, exemplary embodiments of the present invention will be described with reference to the exemplary drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear. In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

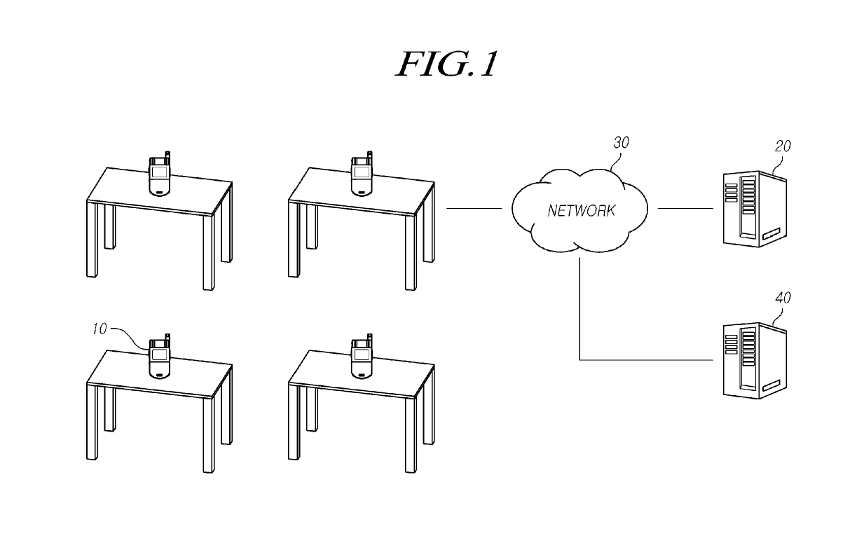

FIG. 1 is a diagram illustrating an example of a test system to which embodiments of the present invention are applied.

With reference to FIG. 1, the test system includes an examinee equipment 10 provided for an examinee, a test managing server 20 connected to the examinee equipment 10 through a network 30, and a teacher equipment 40 connected to the test managing server 20 through the network.

The examinee equipment 10 is an equipment provided for each examinee. The examinee equipment 10 is an electric apparatus that can communicate through the network, and an example thereof may be a desktop computer, a laptop computer, a tablet PC, a PDA, a smart phone, or the like, but is not limited thereto. The examinee equipment 10 may be an apparatus dedicated to a test provided by a test presenter, or may be a general-purpose apparatus with an application for the test which may be provided by the test presenter or possessed by the examinee.

The examinee equipment 10 realizes a digital Optical Mark Reader (OMR) answer sheet which is identical or similar to a real OMR card. The examinee may input an answer using the OMR answer sheet of the examinee equipment 10 in a mock test or a question solving learning process.

Alternatively, the examinee equipment 10 realizes a digital test sheet with a design identical or similar to a real test sheet. The examinee may input an answer using the test sheet of the examinee equipment 10 in the mock test or the question solving learning process.

Further, the examinee equipment 10 may realize the digital OMR answer sheet and the digital test sheet at the same time.

The test managing server 20 may transmit at least one of the configuration information of the OMR answer sheet and the configuration information of the test sheet, to the examinee equipment 10. Furthermore, the test managing server 20 may receive information relating to the input content to at least one of the OMR answer sheet and the test sheet of the examinee equipment 10. The test managing server 20 may score the test based on the information relating to the OMR answer sheet or the information relating to the test sheet received from the examinee equipment 10, and analyze the question solving habits of each examinee. The content analyzed by the test managing server 20 may be transmitted to the teacher equipment 40 to be used for education by the teacher.

The network 30 that connects the examinee equipment 10 and the test managing server 20 may be a wired or wireless Internet network. Alternatively, the network 30 may be a Personal Area Network (PAN) such as the Institute of Electrical and Electronics Engineers (IEEE) 802.15.x, Zigbee, Internet Engineering Task Force (IETF), Routing Over Low power and Lossy networks (ROLL), and International Society of Automation (ISA) 100.11a, or a Local Area Network (LAN) such as Power Line Communication (PLC), Meter-BUS (M-BUS), a wireless M-BUS, and KNX.

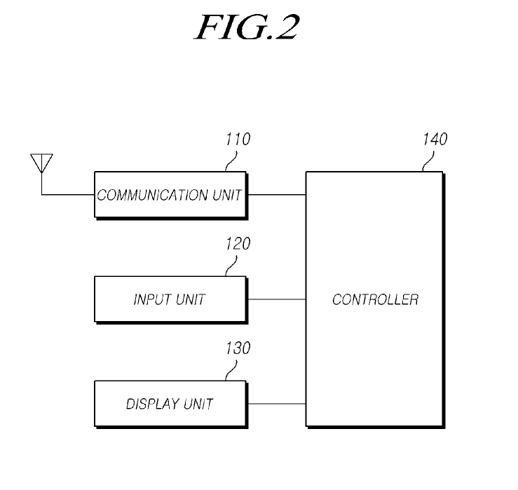

FIG. 2 is a block diagram illustrating a configuration of an examinee equipment in FIG. 1.

With reference to FIG. 2, the examinee equipment 10 includes a communication unit 110 that communicates with the test managing server 20 through the network 30, an input unit 120 that receives answers input by the examinee, a display unit 130 that displays at least one of the test sheet and the answer sheet, and displays answers input by the examinee on the at least one of the test sheet and the answer sheet, and a controller 140.

The input unit 120 may include an input apparatus used in an electronic apparatus such as a mouse, a touch screen, and a keypad. The examinee may input answers through the input unit 120.

The display unit 130 may display a test sheet or an answer sheet in an OMR format. The test sheet or the answer sheet displayed on the display unit 130 may be generated based on the test sheet setting information or the answer sheet setting information received from the test managing server 20 through the communication unit 110. For example, the test sheet setting information may include information on test subjects, questions, answers for each question, or the like, and the answer sheet setting information may include test subjects, the number of questions, the number of answers for each question, or the like. Further, the display unit 130 may display answers input by the examinee through the input unit 120. When a touch screen is used, the input unit 120 and the display unit 130 may be the same configuration.

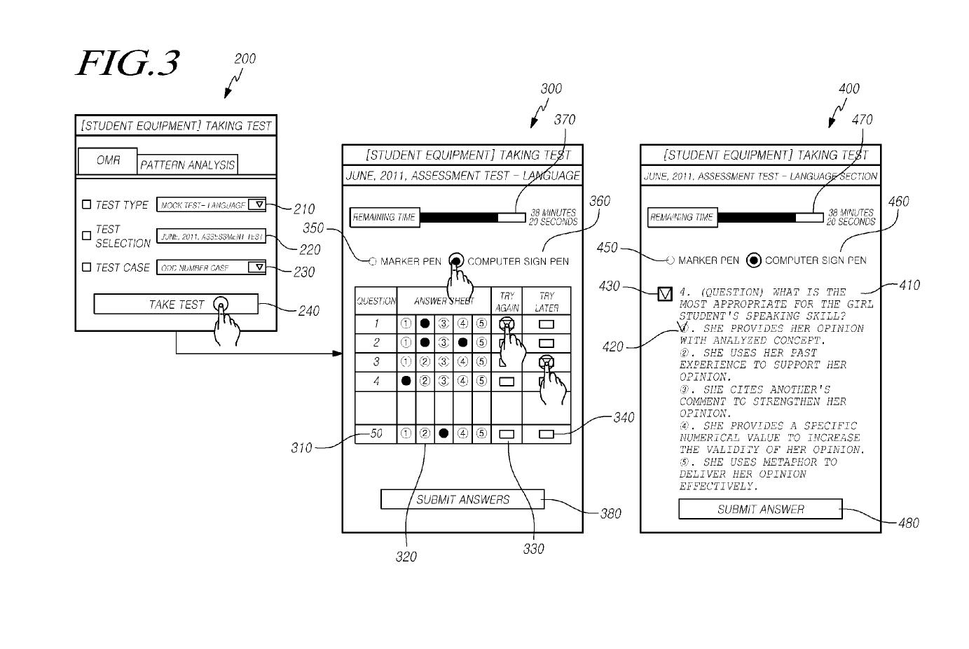

FIG. 3 is a diagram illustrating a screen displayed on the display unit 130 of the examinee equipment according to the first embodiment.

With reference to FIG. 3, the OMR answer sheet displayed on the display unit 130 includes initial screens 200, an answer sheet screen 300 and/or a test sheet screen 400.

The initial screen 200 may include a test type selection window 210, a test selection window 220, a test case selection window 230, and a test taking button 240. The test type selection window 210 is a window on which kinds of tests (for example, a mock test) or a test subject can be selected. The test selection window 220 is a window on which detailed information about the test (for example, a test providing organization) may be selected. The test case selection window 230 is a window on which a test case (an odd numbered case or an even numbered case) can be selected. The test taking button 240 is a button for taking a test after the examinee makes selections in the test type selection window 210, the test selection window 220, the test case selection window 230, and the like. The test type selection window 210, the test selection window 220, the test case selection window 230, and the test taking button 240 are described as examples, and the present invention is not limited thereto.

For example, if the examinee taps the test taking button 240, the display unit 130 may be converted to the answer sheet screen 300 or the test sheet screen 400.

Alternatively, the initial screen may include a QR code window. The QR code window may display a QR code captured by a camera (not illustrated) of the examinee equipment 10. The QR code captured by the examinee equipment 10 may be displayed on a material (for example, a test sheet) provided to the examinee or the like. If the QR code is displayed on the QR code window, the display unit 130 may be converted to the answer sheet screen 300 or the test sheet screen 400 corresponding to the QR code.

With reference to FIG. 3, the answer sheet screen 300 may include a question number 310, answer input boxes 320 for each question, a try-again check box 330 for each question, a try-later check box 340 for each question, input pen selection boxes 350 and 360, a time display window 370, and a submit answer window 380.

The examinee may check an answer which is thought to be a correct answer among the answer input boxes 320 corresponding to the question number 310 for each question.

The try-again check box 330 is a window which can be checked by the examinee if the examinee inputs the answer to the answer input boxes 320 with respect to the uncertain question and wants to review the answer later. The try-again check box 330 may be activated to be checked after the examinee inputs an answer to an answer input box 320.

The try-later check box 340 is a window which can be checked by the examinee, if the examinee does not input an answer to an answer input box 320 with respect to an uncertain question, and wants to input an answer later. The try-later check box 340 may be activated to be checked only before an answer is input to an answer input box 320 by the examinee.

The input pen selection box may include a marker pen selection box 350 and a computer sign pen selection box 360, and a user may select any one of those. That is, if the user selects the marker pen selection box 350, the selection of the computer sign pen selection box 360 may be released, and if the computer sign pen selection box 360 is selected, the selection of the marker pen selection box 350 may be released.

When the marker pen selection box 350 is selected, if the examinee inputs an answer to an answer input box 320, the selected answer may be displayed to be red. Meanwhile, when the computer sign pen selection box 360 is selected, if the examinee inputs an answer to an answer input box 320, the selected answer may be displayed in black.

The answer displayed to be red may not be regarded as a real answer selected by the examinee when the answer is scored. In contrast, the answer displayed to be black may be regarded as a real answer selected by the examinee when the answer is scored. The examinee may mark an answer basically in black (computer sign pen) and mark an example which was once considered to be marked as an answer but was not marked in black, in red (marker pen). Meanwhile, it is possible to activate the try-again check box 330 for an input, only when the examinee checks the answer input boxes 320 in red.

Alternatively, the input pen selection box may include a pencil selection box and a computer sign pen selection box, and the user may select any one of them. The answer input by the examinee to the answer input boxes 320 when the pencil selection box is selected may be displayed to be different from an answer input to the answer input boxes 320 by the examinee when the computer sign pen selection box is selected. For example, when the computer sign pen selection box is selected, the answer may be darker than when the pencil selection box is selected.

The answer displayed with the pencil and the answer displayed with the computer sign pen may be regarded as real answers selected by the examinee. However, a configuration can be made so that if the answer is selected with the computer sign pen, the answer may not be modified, but if the answer is selected with the pencil, the answer may be modified.

Alternatively, the input pen selection box may include a marker pen selection box and a pencil selection box.

The marker pen selection box, the computer sign pen selection box, and the pencil selection box are described as examples, and it is possible to provide another type of input method.

The time display window 370 may display a total test time, a duration time, a remaining time, and the like. The time display window 370 may display the total test time, the duration time, and the remaining time with graphics or text.

A submit answer button 380 is a button which is tapped by the examinee when the examinee finishes the test and submits answers. For example, the submit answer button 380 may be activated after all the questions are checked in black. Alternately, if the submit answer button 380 is tapped when all the questions are not checked in black, a window that confirms whether the answers are to be submitted or not may be generated.

Further, if the examinee taps the test taking button 240, the display unit 130 may be converted to the test sheet screen 400. With reference to FIG. 3, the test sheet screen 400 may include a question 410, an answer 420 for each question, a check box 430 for each question, input pen selection boxes 450 and 460, a time display window 470, and a submit answer window 480.

The examinee may read a question and answers for the question, and may select an answer considered to be a correct answer. In order to differentiate other answers with the answer selected by the examinee, the answer selected by the examinee may be displayed differently. With reference to FIG. 3, for example, a check mark may be displayed on the number selected by the examinee.

The check box 430 is a window that can be checked by the examinee when the examinee inputs an answer to the uncertain question and wants to review the answer, or can be checked by the examinee when the examinee does not input an answer and wants to input the answer later, with respect to an uncertain question by the examinee.

FIG. 3 illustrates one check box 430, but it is possible to use one or more check boxes with special functions such as a try-again check box used for reviewing an answer after the answer is input or a try-later check box used for inputting an answer later. For example, it is possible that the try-again check box is activated only after the examinee selects an answer and the try-later check box is activated only before the examinee selects an answer.

The input pen selection box may include a marker pen selection box 450 and a computer sign pen selection box 460, and the user may select at least one of those. That is, if the user selects the marker pen selection box 450, the selection of the computer sign pen selection box 460 is released, and if the user selects the computer sign pen selection box 460, the selection of the marker pen selection box 450 may be released.

If the marker pen selection box 450 is selected, when the examinee selects an answer, the selected answer may be checked in red. Meanwhile, if the computer sign pen selection box 460 is selected, when the examinee selects an answer, the selected answer may be checked in black.

The answer checked in red may not be considered as a real answer which is not selected by the examinee when the answer is scored. Meanwhile, the answer checked in black may be considered as a real answer which is selected by the examinee when the answer is scored. The examinee checks an answer basically in black (computer sign pen), and check an example which was considered to be marked as an answer other than the answer checked in black, in red (marker pen). Meanwhile, it is possible to activate the try-again check box 330 for an input, only when the examinee checks the answer in red.

The time display window 470 may display a total test time, a duration time, a remaining time, and the like. The time display window 470 may display the total test time, the duration time, the remaining time, and the like with graphics and text.

A submit answer button 480 is a button which is tapped by the examinee when the examinee finishes the text and submits the answer. For example, the submit answer button 480 may be activated after the answer is checked in black with respect to all the questions. Otherwise, if the submit answer button 480 is tapped when all the questions are not checked in black, a window that confirms whether the answers are to be submitted or not may be generated.

According to another embodiment, if the examinee taps the test taking button 240, the display unit 130 may simultaneously display the answer sheet screen 300 and the test sheet screen 400. Alternatively, the display unit 130 displays one of the answer sheet screen 300 and the test sheet screen 400 according to the selection of the examinee, and the answer sheet screen 300 and the test sheet screen 400 may be substituted with each other according to the instruction of the examinee.

According to the present embodiment, when the examinee checks an answer input box 320 of the answer sheet screen 300, a corresponding answer 420 of the test sheet screen 400 may be checked or when the examinee selects an answer 420 of the test sheet screen 400, an answer input box 320 corresponding to the answer sheet screen 300 may be checked.

With reference to FIG. 2, the controller 140 may generate the examinee's test information based on the information input by the examinee through the input unit 120. The examinee's test information may include information on answers input by the examinee, question-specific time taken by the examinee with respect to each question, information on the total time taken by the examinee for all questions, information on a sequence in which the examinee input the answers for the questions, information on whether the examinee performed a try-again or try-later input for checking uncertain questions, and the like.

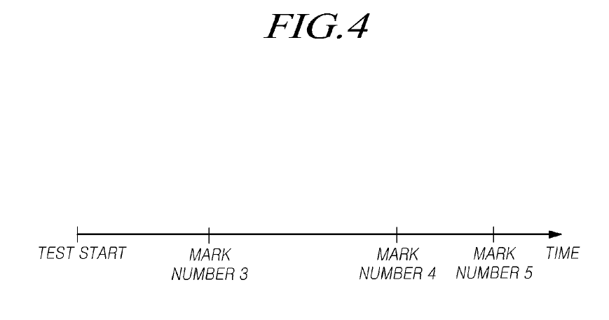

FIG. 4 is a diagram illustrating an example of a method of measuring question-specific time.

In FIG. 4, the examinee inputs answers in a sequence of question numbers 3, 4, and 2, after the test starts. At this point, the time on the question first solved by the examinee (question number 3) may be a time from the test start time to the time of inputting an answer to the corresponding question (question number 3). Otherwise, the time on the question which is not solved first (for example, question number 4) may be a time from the time of inputting an answer to the previous question (question number 3) to the time of inputting an answer to the corresponding question (question number 4).

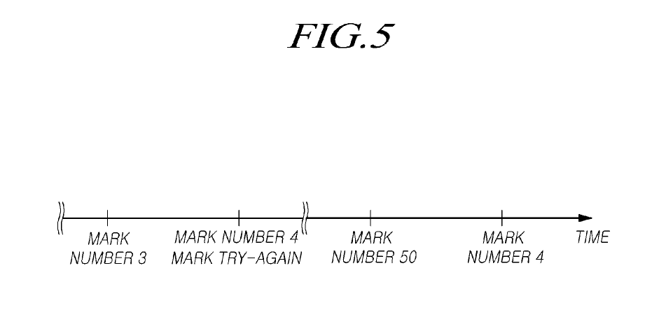

FIG. 5 is a diagram illustrating another example of a method of measuring question-specific time.

FIG. 5 illustrates a method of measuring question-specific time when the examinee performs a try-again or try-later input. In FIG. 5, the examinee inputs an answer to question number 4 after inputting an answer to question number 3, and checks a try-again box, since the answer to question number 4 is uncertain. Thereafter, the examinee inputs an answer to question number 4, after inputting an answer to question number 50. In this case, the time for question number 4 may be a time obtained by adding a time from the time of inputting the answer to the previous question (question number 3) to the time of checking a try-again box for the corresponding question (question number 4), and a time from the time of inputting an answer to the previous question (question number 50) to the time of inputting an answer to the corresponding question (question number 4).

Further, if the try-later box is checked, in a similar manner to the try-again box, the time may be obtained by adding a time from the time of inputting the answer to the previous question to the time of checking a try-later box for the corresponding question, and a time from the time of inputting an answer to the previous question to the time of inputting an answer to the corresponding question.

Meanwhile, the time on a question which is solved after the question for which a try-again or try-later box is checked may be calculated based on the time at which the try-again or try-later box is checked.

Further, the examinee's test information may include information on total time by the examinee on all questions. The total time may be a time from when the test starts to when the answer submit button 380 is tapped. Otherwise, the total time may be the sum of the question-specific time.

Alternatively, the examinee's test information may include information on a sequence of inputting answers for questions by the examinee.

Further, the examinee's test information may include information on whether a try-again or try-later box for each question was checked or not for checking an uncertain question.

Further, the examinee's test information may include information on answers marked in red in addition to answers marked in black.

The examinee's test information described above may be transmitted to the test managing server 20 by the communication unit 110 when the examinee taps a submit answer button 380 or 480.

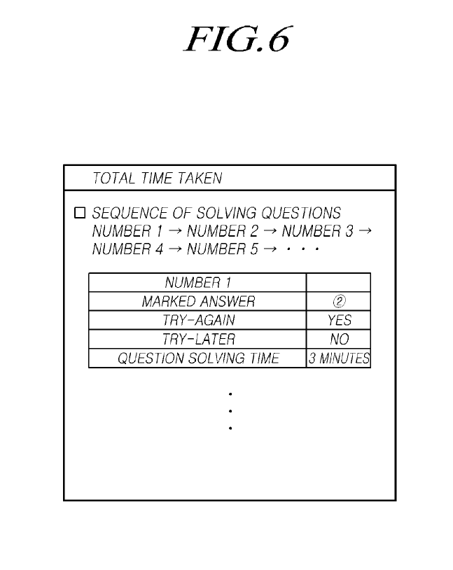

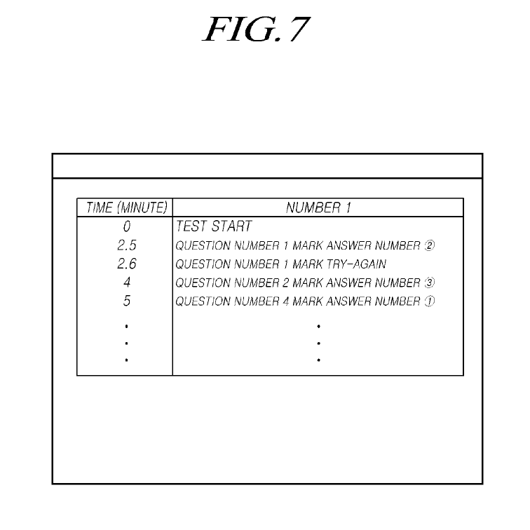

FIGS. 6 and 7 are diagrams illustrating data including the examinee's test information in an examinee equipment and transmitted to the test managing server.

In FIG. 6, the data may include information on the total time, and information on a sequence of solving questions. Further, the data may include information on a marked answer for each question, information on a try-again or try-later input, information on question solving time, and information on answer changes. In FIG. 6, the examinee's test information may be transmitted in a form arranged by the controller 140 of the examinee equipment 10.

In FIG. 7, the data may include contents input by the examinee according to time. The data include all actions input by the examinee arranged by time. In FIG. 7, the arranged form of the examinee's test information may be extracted from the test managing server.

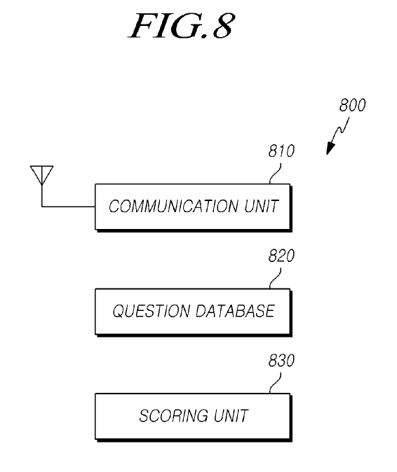

FIG. 8 is a block diagram illustrating a configuration of a test managing server 800 according to an embodiment of the present invention.

With reference to FIG. 8, the test managing server 800 includes a communication unit 810, a question database 820, and a scoring unit 830.

The communication unit 810 is configured to communicate with an examinee equipment through a network. Further, the communication unit 810 can be used to communicate with a teacher equipment described below.

The question database 820 includes data on questions of the tests performed by the examinee and data on correct answers thereof.

According to kinds of tests taken by the examinee, test sheet configuration information or answer sheet configuration information may be generated based on data (for example, the number of questions, the number of answers) on the test questions stored in the question database 820. Such test sheet setting information or answer sheet setting information may be transmitted to the examinee equipment through the communication unit 810.

Based on the information on the correct answers in the test taken by the examinee, the scoring unit 830 may score answers of the examinee.

Further, the question database 820 may include information on attributes of each question. The question attribute information may include difficulty of questions (for example, high, middle, low), types of questions (for example, understanding, application, or advanced), unit information, or the like. The information on the units may be hierarchically configured into a category, a division, and a section. The question attribute information may be used for analyzing the examinee's test result and counseling the examinee.

The scoring unit 830 scores answers of the examinee using the examinee's test information received from the examinee equipment.

Further, the scoring unit 830 may perform analysis and statistics based on the examinee's test information to provide the analysis statistics information. In more detail, the scoring unit 830 may provide information relating to the examinee's question solving habit and information relating to scores. For example, the analysis statistics information provided by the scoring unit 830 may be as presented in Table 1 below.

TABLE 1

| Question solving pattern | |
|---|---|
| information | Information relating to scores |
| Time measurement function | Result score |
| Solution sequence | Correct/incorrect answers for each |
| Uncertain question advance | question |
| check function | Incorrect answer question number set |
| | Uncertain question number set |
| | Weak unit |
| | Question-specific pattern comparison |

The time measurement function may be used to determine whether the examinee manages test time effectively.

The solution sequence may be used to determine the test habits of the examinee along with the question attribution information. For example, the solution sequence may be used to determine whether the solution sequence has a correlation with the distributed points for the question, the difficulty, the unit, and the like.

The uncertain question advance check function may be used to determine whether the examinee checks unsure questions in advance to take the test cautiously.

The result score refers to the test score of the examinee.

The correct/incorrect answer for each question refers to whether the examinee selects a correct answer or an incorrect answer for each question.

The incorrect answer question number set provides questions for which the examinee inputs incorrect answers.

The uncertain question number set provides questions selected by the examinee during a solving process by marking try-again or try-later boxes with respect to uncertain questions. Regardless of whether the answer is correct or incorrect, since the examinee is uncertain, the questions may be provided as information.

The weak unit may present a unit name corresponding to the question for which an incorrect answer is input or a unit name corresponding to the question of which the examinee is uncertain. In addition to the weak unit, it is possible to provide a weak type that presents a type (for example, understanding, application, or advanced) corresponding to a question for which an incorrect answer was input or which is uncertain.

The question-specific pattern comparison may be provided by analyzing pattern information of all test taking students with respect to each question. For example, the question-specific pattern comparison may be as presented in Table 2 below.

TABLE 2
Question-specific pattern comparison

| | |
|---|---|
| Answer selected by examinee | Question solving time of examinee |
| Actual correct answer | Average question solving time of all |
| Correct/Incorrect | examinee |
| Percentage of correct answers | Whether examinee checks try- |
| out of entire examinees | again/try-later |
| Percentage of correct answers | Percentage of examinees who checks |
| out of high-level examinees | try-again/try-later out of all |
| | examinees |

The analysis statistics information described above may be provided to a teacher equipment to be used when the teacher counsels the examinee or be provided to an examinee equipment so that the examinee may check his/her own question solving habits. The details of the analysis statistics information provided with the teacher equipment and the examinee equipment may be different.

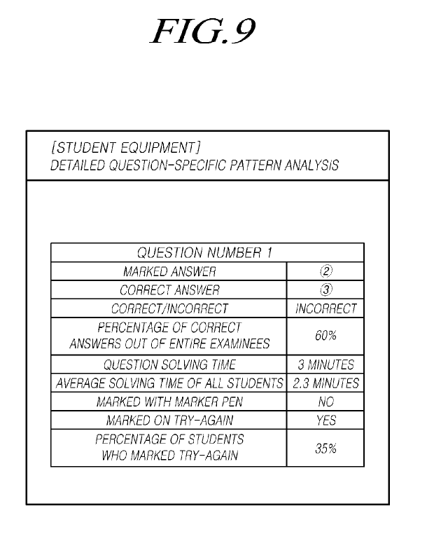

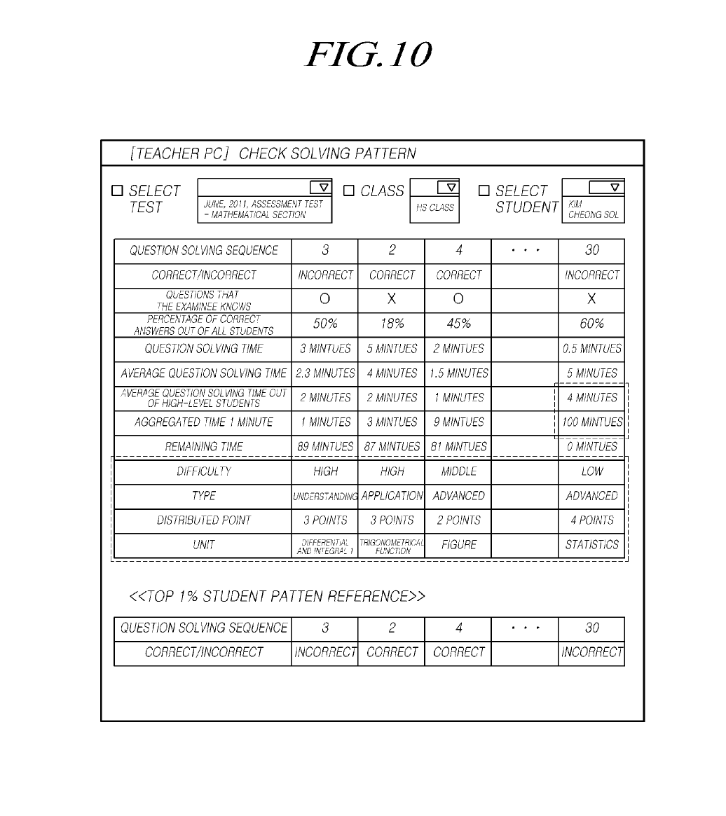

FIGS. 9 and 10 are diagrams illustrating examples of solving pattern check screens displayed on a teacher equipment.

With reference to FIG. 9, the solving pattern check screen may include information such as a question solution sequence, whether the examiner's answer for each question is correct or incorrect, a percentage of correct answers out of all examinees, question solving time by the examinee, average question solving time by all examinees, average question solving time by high-level examinees (for example, top 1% examinees), total time, remaining time, difficulty, a question type, distributed points, and a unit.

With reference to FIG. 10, the solving pattern check screen may provide the number of questions, scores, and time with respect to questions that the examinee knows, questions that the examinee does not know, or questions of which the examinee is uncertain. The uncertain questions may correspond to the number of questions for which a try-again or try-later box is marked by the examinee. Alternatively, the uncertain questions may correspond to the number of questions of which answers marked by the examinee are changed.

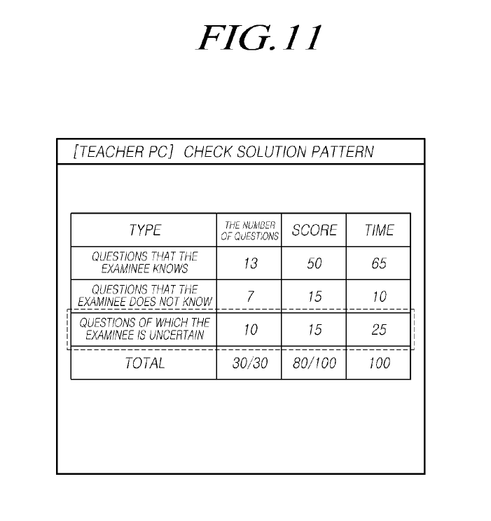

FIG. 11 is a diagram illustrating a screen of detailed question-specific pattern analysis displayed on a teacher equipment.

With reference to FIG. 11, the screen of detailed question-specific pattern analysis includes answers selected by the examinee, actual correct answers, whether answers are correct or incorrect, a percentage of correct answers out of all examinees, question solving time by the examinee, average question solving time by all examinees, whether try-again or try-later boxes are marked or not, a percentage of examinees who marked try-again or try-later boxes out of all examinees, whether marking is performed with a marker pen (red), and the like.

FIGS. 10 and 11 are diagrams illustrating analysis results with respect to each examinee.

Further, information displayed on the teacher equipment may be information on all examinees (for example, the number of examinees, an average score of all examinees, an average score of high-level examinees, an average solving time of all examinees, and an average solving time of high-level examinees) or question-specific analysis information (for example, with respect to each question, correct answers, average solving time, a percentage of a correct answers, a selection percentage with respect to each answer, and the like).

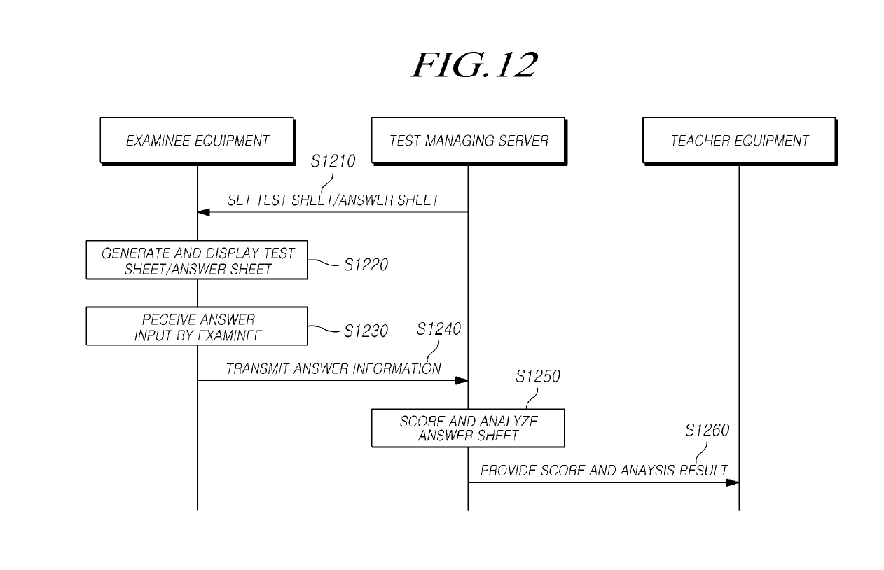

FIG. 12 is a flowchart illustrating a test progressing method according to a first embodiment of the present invention.

With reference to FIG. 12, the test managing server transmits test sheet setting information or answer sheet setting information to the examinee equipment in step S1210. The test sheet setting information or the answer sheet setting information may include a test subject, a test type, contents of questions or the number of questions, and contents of answers or the number of answers for each question.

The examinee equipment generates a test sheet and/or an OMR answer sheet based on the test sheet setting information or the answer sheet setting information in step S1220. More specifically, the examinee equipment may generate a test sheet based on the contents of the questions and the contents of the answers or generate an answer sheet based on the number of questions and the number of answers. Further, the examinee equipment may further display windows for checking try-again or try-later boxes for each question. In addition, the examinee equipment may further display a computer sign pen selection box that can be used to mark answers in black and a marker pen selection box that can be used to mark examples considered to be selected other than the answers marked in black, in red. Further, the examinee equipment may further display a submit answer button to submit answers when the examinee completes answer inputs.

The examinee equipment receives answer signals input by the examinee in step S1230. Further the examinee equipment transmits answer sheet information to the test managing server in step S1240.

In addition to the information on answers input by the examinee, the answer sheet information may include information on a sequence of questions for which the examinee inputs answers, information on question-specific time which is time used by the examinee to input an answer for each question, information on whether the examinee checks try-again or try-later boxes to check uncertain questions, and information on whether the examinee selects marker pen selection boxes to mark answers. Such information may be provided as data for counseling the examinee. The test managing server receives answer sheet information scores and analyzes the answer sheet of the examinee in step S1250.

The test managing server may analyze question solving patterns of the examinee such as time taken by the examinee for solving questions, a solution sequence, and advance checks on uncertain questions.

Further, the test managing server analyzes result scores, correct/incorrect answers for each question, questions for which incorrect answers are input or which are uncertain (questions for which try-again or try-later boxes are checked), and units relating to the questions for which the incorrect answers are input or which are uncertain (questions for which try-again or try-later boxes are checked).

Further, the test managing server may analyze a question-specific pattern comparison with respect to each question. The question-specific pattern comparison may include answers selected by the examinee, actual correct answers, whether answers are correct or incorrect, a percentage of correct answers out of all examinees, question solving time of the examinee, an average question solving time of all examinees, whether the examinee selects try-again or try-later boxes, and a percentage of examinees who select try-again or try-later boxes out of all examinees.

The score and analysis result may be provided to the teacher equipment in step S1260 so that the teacher may use the score and analysis result for counseling. Further, the score and analysis result may be provided to the examinee equipment so that the examinee can refer to the score and analysis result.

The analysis statistics information described above can be applied to an actual question solving exercise in preparation for tests by examinees or educational institutions. Therefore, test taking patterns may be analyzed which was not possible in conventional paper test sheets or paper OMR answer sheets. The analysis result may be used as helpful information by teachers in educational institutions to recognize question solving habits of examinees and teach the examinees.

The analysis statistics information function of the OMR answer sheet is applicable to general workbooks in addition to question solving exercises such as mock tests, so the analysis statistics information function may be utilized in combination with paper teaching materials in the publishing industry. For example, using an equipment that can connect to a server through a network and display a digital OMR screen, solutions to questions of the paper teaching material (workbook) can be provided.

Such digital test sheets or digital OMR answer sheets may be used for all kinds of multiple choice test exercises, and may be used by examinees and institutions that provide services providing solutions to questions relating to tests since the digital test sheets or digital OMR answer sheets provide information which was not possible to be recognized so far.

The embodiment described above suggests providing OMR answer sheets or digital test sheets to the examinee equipment 10 by the test managing server 20 in FIG. 1. Meanwhile, according to a second embodiment, the examinee equipment 10 may progress tests without an OMR answer sheet provided by the test managing server 20. In this case, the progress of the test is described as follows.

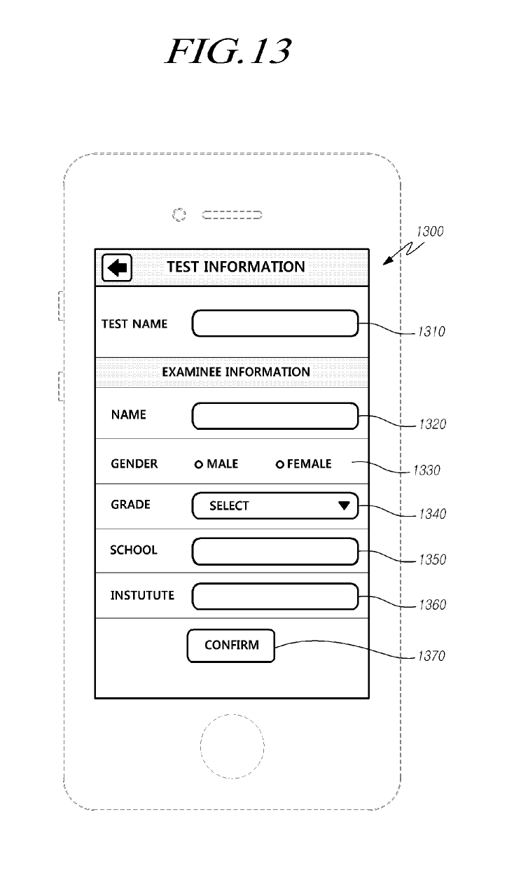

FIG. 13 is a diagram illustrating an application information input screen displayed on an examinee equipment according to a second embodiment.

With reference to FIG. 13, an application information input screen 1300 includes a test name input box 1310, a name input box 1320, a gender input box 1330, a grade input box 1340, a school input box 1350, an institute input box 1360, and a confirm button 1370.

The test name input box 1310 is used to input a test which the examinee currently wants to take. The examinee may input a test name by selecting one among a plurality of tests set in advance or by inputting the test name directly.

For example, the answer sheet may be set according to the test name input to the test name input box 1310.

For example, as described in Table 3 below, if a test type and a section/subject are input to the test name input box 1310, the number of questions, a question configuration, test time, preliminary marking, and the like may be determined in advance.

TABLE 3

| | | | | | Prelimi- |
|---|---|---|---|---|---|
| | Section/ | Number of | Question | Test | nary |
| Test type | Subject | questions | configuration | time | marking |
| Mock test | Korean | 45 | All multiple | 80 | Pencil |
| of College | (Case A/ | | choice | minutes | |
| Scholastic | Case B) | | questions | | |
| Ability | Math | 30 | 21 multiple | 100 | Pencil |
| Test and | (Case A/ | | choice | minutes | |
| Academic | Case B) | | questions | | |
| assessment | | | (Nos. 1 to | | |
| test (high | | | 21) +9 short- | | |
| school) | | | answer | | |
| | | | questions | | |
| | | | (Nos. 22 to | | |
| | | | 30) | | |
| | English | 50 | All multiple | 70 | Pencil |
| | (Case A/ | | choice | minutes | |
| | Case B) | | questions | | |
| | Social | 20 | All multiple | 30 | Pencil |
| | Studies/ | | choice | minutes | |
| | Science | | questions | | |

For example, if the examinee selects a mock test of the College Scholastic Ability Test and a math section in the test name input box 1310, an OMR answer sheet for 21 multiple choice questions and 9 short-answer questions is generated and displayed subsequently. At this point, the test time is set to be 100 minutes, and the preliminary marking may be implemented with a pencil before the final marking.

Otherwise, a configuration may be possible so that the examinee may directly input at least one kind of information such as the number of questions, a question configuration, test time, and preliminary marking.

With reference to FIG. 13, the name input box 1320, the gender input box 1330, the grade input box 1340, the school input box 1350, the institute input box 1360, and the like may be used to input information of the examinee. The examinee may select or directly input one of a plurality of configurations to the name input box 1320, the gender input box 1330, the grade input box 1340, the school input box 1350, and the institute input box 1360

The examinee taps the confirm button 1370 when the inputs of the application information input screen 1300 are completed. Thereafter, the test taker progresses the test using an OMR answer sheet displayed on the examinee equipment.

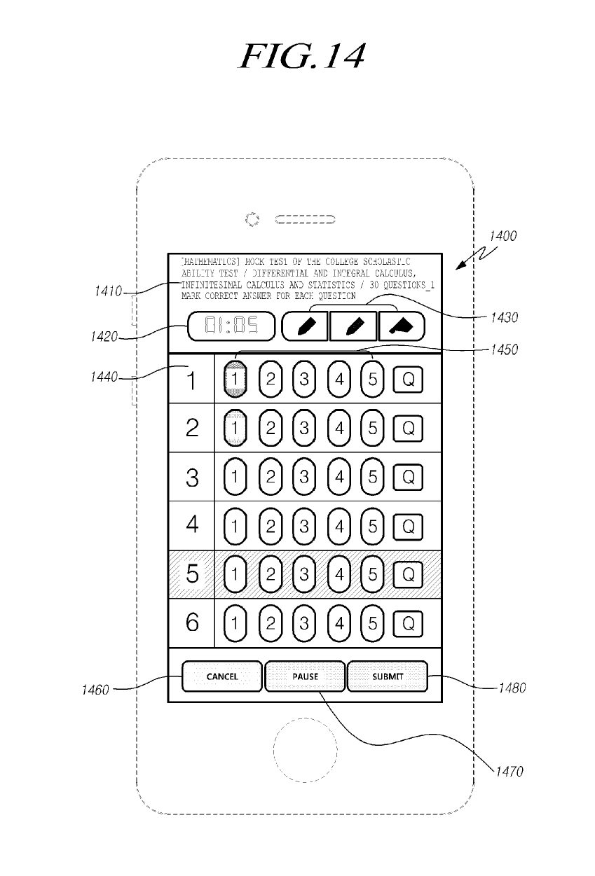

FIG. 14 is a diagram illustrating an OMR answer sheet displayed on the examinee equipment.

With reference to FIG. 14, the OMR answer sheet includes a test information display window 1410, a time display window 1420, an input pen selection box 1430, a question number 1440, an answer input box 1450 for each question, a test cancel button 1460, a pause button 1470, and a submit answer button 1480.

The test information display window 1410 may display information input in the test name input box 1310.

The time display window 1420 may display total test time, duration time, remaining time, and the like.

The input pen selection box 1430 may be provided to select marking when the final answers are submitted (for example, a computer sign pen), preliminary marking (for example, a red color marker pen or a pencil), or an eraser to erase the input marking.

The examinee may check an answer which is considered to be a correct answer among answer input boxes 1450 corresponding to the question number 1440 for each question.

The test cancel button 1460 is a button tapped when the examinee cancels the test, and the pause button 1470 is a button tapped when the examinee pauses the test.

The submit answer button 1480 is a button tapped by the examinee when the examinee completes the test and submits answers.

When the examinee completes answer inputs and submits answers by tapping the submit answer button 1480, the test result screen may be displayed on the examinee equipment.

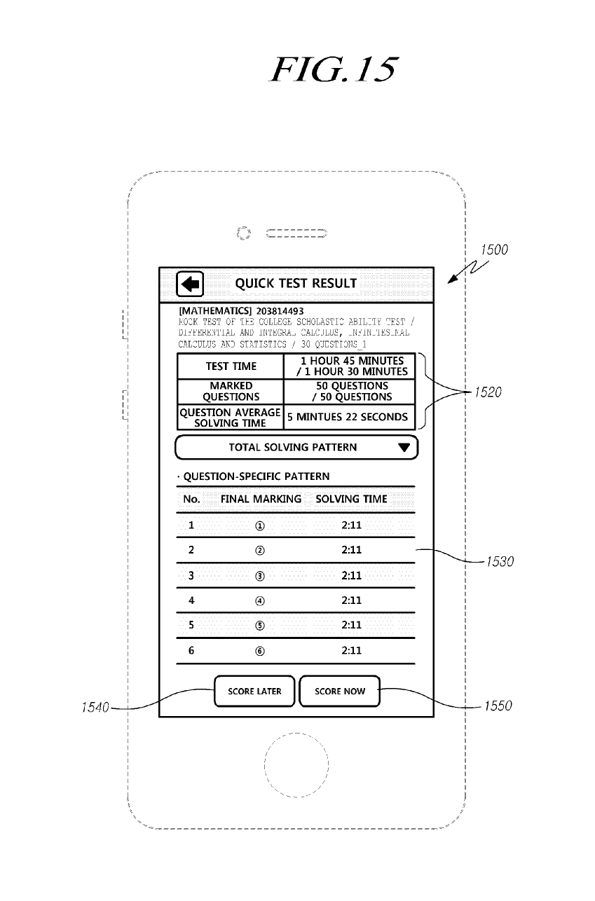

FIG. 15 is a diagram illustrating an example of a test result screen displayed on the examinee equipment.

With reference to FIG. 15, a test result screen 1500 includes a test information display window 1510, a test result information display window 1520, a pattern-per-question display window 1530, a scoring-later button 1540, and a scoring button 1550.

The information input in the test name input box 1310 in FIG. 13 may be displayed on the test information display window 1510.

The test result information display window 1520 may display allowed test taking time, test taking time actually taken by the examinee, all questions, questions actually marked by the examinee, an average question-specific solving time, and the like.

The pattern-per-question display window 1530 may display an answer input by the examinee for each question and question-specific time. The question-specific time may be calculated as described above with reference to FIGS. 4 and 5.

The scoring-later button 1540 is a button tapped to score answers later.

The scoring button 1550 is a button tapped to score answers by the examinee. When the examinee taps the scoring button 1550, the scoring screen may be displayed on the examinee equipment.

Alternatively, a scoring button may be positioned on the OMR answer sheet of FIG. 14. In this case, the examinee may proceed to score answers right after submitting answers, and the test result screen of FIG. 15 may be omitted. Alternately, a screen obtained by combining the test result screen of FIG. 15 with a scoring screen to be described below may be displayed.

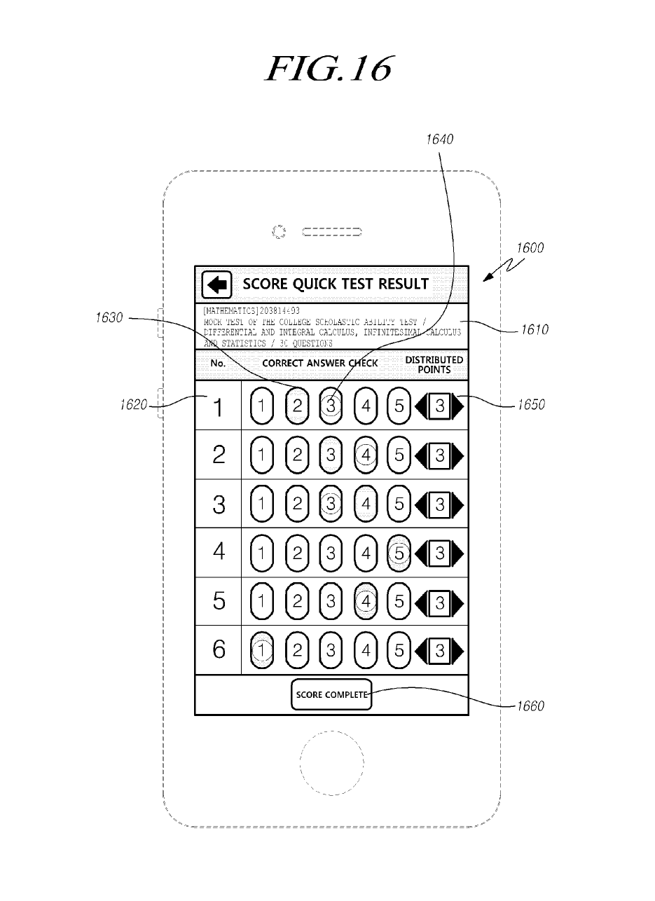

FIG. 16 is a diagram illustrating a scoring screen displayed on the examinee equipment.

With reference to FIG. 16, a scoring screen 1600 may include a test information display window 1610, a question number 1620, a marked answer 1630, a correct answer 1640, a distributed point setting window 1650, and the scoring completion button 1660.

The information input to the test name input box 1310 in FIG. 13 may be displayed on the test information display window 1610.

Answers which the examinee input in the OMR answer sheet in FIG. 14 with respect to each of the question numbers 1620 may be displayed as the marked answers 1630. Further, the examinee may directly input the correct answer 1640 of the test. If the marked answer 1630 is identical to the correct answer 1640, it is determined that the marked answer 1630 is correct, and if the marked answer 1630 is not identical to the correct answer 1640, it is determined that the marked answer 1630 is incorrect.

The distributed point setting window 1650 is positioned to set a question-specific distributed point. The examinee that scores the answers may set a distributed point corresponding to the distributed point setting window 1650.

The scoring completion button 1660 may be tapped when the examinee completes the scoring. The scoring completion button 1660 may be configured to be activated when the examinee performs the scoring with respect to all the questions.

When the scoring completion button 1660 is tapped, a total score is calculated based on whether the marked answer 1630 and the correct answer 1640 are identical to each other with respect to each question and distributed points 1650, and the examinee may check the calculated total score.

Further, when the scoring is completed, the test information of the examinee may be transmitted from the examinee equipment 10 to the test managing server 20. The information transmitted to the test managing server 20 may include test information (input to the test name input box 1310 in FIG. 13), information of the total time, information on question-specific time, information on a sequence of solving the questions, information on marked answers for each question, information on correct answers for each question, information on whether the examinee input a correct answer for each question, question-specific distributed points, information on whether the examinee performed preliminary marking for each question, information on whether the examinee modified the marking for each question, and the like.

The test managing server 20 may perform analysis and statistics based on information received from the examinee equipment 10, and provide analysis statistics information. More specifically, the test managing server 20 may provide information on question solving patterns of the examinee and information on scores. As described above with reference to Table 1, information on the question solving patterns may include a time measurement function, a solution sequence, an uncertain question advance check function, and the like may include a result score, correct/incorrect answers for each question, an incorrect answer question number set, an uncertain question number set, weak units, question-specific pattern comparison, and the like.

The test managing server 20 may find a plurality of examinees that took the same test with test information, and analyze and provide pattern information of all examinees with respect to the same test. As described above with reference to FIG. 2, with respect to each question, the test managing server 20 may provide answers selected by the examinee, actual correct answers, whether answers are correct or incorrect, a percentage of correct answers out of all examinees, a percentage of correct answers out of high-level examinees, question solving time of the examinee, an average question solving time of all examinees, whether the examinee performed preliminary marking, a percentage of preliminary marking out of all examinees, and the like.

The test managing server 20 may provide the analysis statistics information to the examinee equipment 10 or the teacher equipment 40.

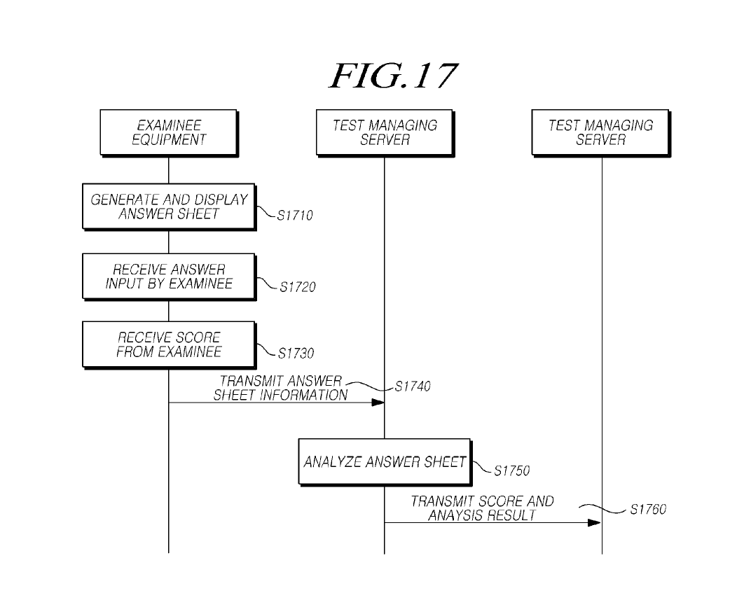

FIG. 17 is a flowchart illustrating a test progressing method according to the second embodiment of the present invention.

With reference to FIG. 17, the examinee equipment generates and displays an answer sheet based on the information input by the examinee in step S1710.

The information input by the examinee may include information on the test and the information on the examinee. The number of questions, a question configuration, test time, and the like may be determined based on the information on the test. Otherwise, the information input by the examinee may include the number of questions, a question configuration, test time, and the like. The examinee equipment may include a window to select final marking, preliminary marking, and answer modifications. Further, the examinee equipment may display a button to submit answers when the examinee completes answer inputs.

The examinee equipment receives answer signals input by the examinee in step S1720, and receives information on the scoring by the examinee after the completion of the test in step S1730. Further, the examinee equipment transmits information on the answers input by the examinee, and information on the scoring by the examinee to the test managing server in step S1740.

The information transmitted from the examinee equipment to the test managing server may include the name of the test, information on the total time, information on question-specific time, information on a sequence of solving questions, information on marked answers for each question, information on correct answers for each question, information on correct/incorrect answers for each question, information on question-specific distributed points, information on whether the examinee performed preliminary marking for each question, information on whether the examinee modified marking for each question, and the like.

The test managing server analyzes answers based on information received from the examinee equipment in step S1750. The test managing server analyzes question solving patterns of the examinee such as time measurement, a solution sequence, and uncertain question advance checking, and information relating to scores such as a result score, correct/incorrect answers for each question, an incorrect answer question number set, an uncertain question number set, weak units, and question-specific pattern comparison. Further, the test managing server may analyze pattern information on all examinees by collecting information on examinees who took the same test. That is, the test managing server may compare a result of the examinees, results of all examinees, and results of high-level examinees.

Further, the test managing server transmits the scoring and analysis result to the teacher equipment in step S1760.

The analysis statistics information described above may be applied to a practical question solving exercise in preparation for a test by examinees and educational institutions. Therefore, test taking patterns may be analyzed which was not possible in conventional paper OMR answer sheets. The analysis result as above may be used as useful information in recognizing the examinee's question solving habits and teaching the examinees by teachers in educational institutions.

The analysis statistics information function of the OMR answer sheet is applicable to general workbooks in addition to question solving exercises such as mock tests, so the analysis statistics information function may be utilized in combination with paper teaching materials in the publishing industry. For example, using an equipment that can connect to a server through a network and display a digital OMR screen, solutions to questions of the paper teaching material (workbook) can be provided.

Such digital OMR answer sheets may be used for all kinds of multiple choice test exercises, and may be used by examinees and institutions that provide services providing solutions to questions relating to tests since the digital OMR answer sheets provide information which was not possible to be recognized so far.

The first and second embodiments described above are presented as examples, and another embodiments combining or modifying the embodiments may be possible. For example, the test sheet and/or the answer sheet displayed on the examinee equipment may be generated based on setting information received from the test managing server as described in the first embodiment and the scoring of the answers may be performed in the examinee equipment as described in the second embodiment. Otherwise, the test sheets and/or the answer sheets displayed on the examinee equipment may be generated based on information input by the examinee as described in the second embodiment, and the scoring of the answers may be performed in the test managing server as described in the first embodiment.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An examinee equipment, comprising:
an input unit that receives answers input by an examinee;
a display unit that displays at least one of a test sheet generated based on test sheet setting information and an answer sheet generated based on answer sheet setting information and displays the answers input by the examinee on at least one of the test sheet or the answer sheet;
a controller that measures question-specific time taken in inputting an answer for each question by the examinee with respect to each question; and
a communication unit that transmits test information of the examinee including information on the answers input by the examinee and information on the question-specific time to a test managing server.

2. The examinee equipment according to claim 1,
wherein the question-specific time is a time from test starting time to time of inputting an answer to a corresponding question if the corresponding question is a first question, and
wherein the question-specific time is a time from time of inputting an answer to a previous question to time of inputting an answer to a corresponding question if the corresponding question is not a first question.

3. The examinee equipment according to claim 1,
wherein the controller further measures total usage time taken in inputting answers for all questions by the examinee, and
wherein the test information of the examinee further includes information on the total usage time.

4. The examinee equipment according to claim 1,
wherein the controller further measures a question sequence of selecting answer inputs by the examinee, and
wherein the test information of the examinee further includes information on the question sequence of selecting the answer inputs.

5. The examinee equipment according to claim 1,
wherein the test sheet or the answer sheet includes a try-again input box to be checked by the examinee to input an answer of a corresponding question again, and a try-later input box to be checked by the examinee to input an answer of a corresponding question later, and
wherein the test information of the examinee further includes information on whether the try-again input box or the try-later input box is checked.

6. The examinee equipment according to claim 5, wherein the question-specific time includes a time from time of inputting an answer of a previous question to time of checking the try-again input box or the try-later input box.

7. The examinee equipment according to claim 1, wherein the controller scores based on a correct answer input by a user or a distributed point input by the user.

8. The examinee equipment according to claim 1, wherein the test sheet setting information or the answer sheet setting information is determined according to a QR code read by the examinee equipment.

9. A test managing server, comprising:
a communication unit that receives information on answers input by an examinee from an examinee equipment; and
a test scoring unit that scores and analyzes the answers based on test information of the examinee including information on the answers input by the examinee and information on question-specific time taken in inputting an answer for each question by the examinee.

10. The test managing server according to claim 9,
wherein the question-specific time is a time from test starting time to time of inputting an answer to a corresponding question if the corresponding question is a first question, and
wherein the question-specific time is a time from time of inputting an answer to a previous question to time of inputting an answer to a corresponding question if the corresponding question is not a first question.

11. The test managing server according to claim 9, wherein the test information of the examinee further includes information on the total usage time taken in inputting answers for all questions by the examinee.

12. The test managing server according to claim 9, wherein the test information of the examinee further includes information on a question sequence of selecting the answer inputs by the examinee.

13. The test managing server according to claim 9, wherein a test sheet or an answer sheet provided for the examinee equipment includes a try-again input box to be checked by the examinee to input an answer of a corresponding question again, or a try-later input box to be checked by the examinee to input an answer of a corresponding question later, and
wherein the test information of the examinee further includes information on whether the try-again input box or the try-later input box is checked with respect to the corresponding question.

14. The test managing server according to claim 13, wherein the question-specific time includes a time from time of inputting an answer of a previous question to time of checking the try-again input box or the try-later input box.

15. A test progressing method executed in an examinee equipment, comprising:
displaying at least one of a test sheet and an answer sheet;
receiving and displaying answers input by the examinee;
measuring question-specific time taken in inputting an answer for each question by the examinee with respect to each question; and
transmitting test information of the examinee including information on the answers input by the examinee and information on the question-specific time with respect to each question, to the test managing server.

16. The test progressing method according to claim 15,
wherein the question-specific time is a time from test starting time to time of inputting an answer to a corresponding question if the corresponding question is a first question, and
wherein the question-specific time is a time from time of inputting an answer to a previous question to time of inputting an answer to a corresponding question if the corresponding question is not a first question.

17. The test progressing method according to claim 15, further comprising:
measuring total usage time taken in inputting answers for all questions by the examinee,
wherein the test information of the examinee further includes information on the total usage time.

18. The test progressing method according to claim 15, further comprising:
measuring a question sequence of selecting answer inputs by the examinee,
wherein the test information of the examinee further includes information on the question sequence of selecting the answer inputs.

19. The test progressing method according to claim 15,
wherein the test sheet or the answer sheet includes a try-again input box to be checked by the examinee to input an answer of a corresponding question again, or a try-later input box to be checked by the examinee to input an answer of a corresponding question later, and
wherein the test information of the examinee further includes information on whether the try-again input box or the try-later input box is checked.

20. The test progressing method according to claim 19, wherein the question-specific time includes a time from time of inputting an answer of a previous question to time of checking the try-again input box or the try-later input box.

21. The test progressing method according to claim 15, further comprising:
scoring based on a correct answer input by a user or a distributed point input by the user.

22. The test progressing method according to claim 15, further comprising:
determining the test sheet setting information or the answer sheet setting information according to a QR code read by the examinee equipment.

23. A test analyzing method executed by a test managing server, comprising:
receiving information on answers input by an examinee from an examinee equipment; and
scoring and analyzing the answers based on test information of the examinee including information on the answers input by the examinee and information on question-specific time taken in inputting an answer for each question by the examinee.

24. The test analyzing method according to claim 23,
wherein the question-specific time is a time from test starting time to time of inputting an answer to a corresponding question if the corresponding question is a first question, and
wherein the question-specific time is a time from time of inputting an answer to a previous question to time of inputting an answer to a corresponding question if the corresponding question is not a first question.

25. The test analyzing method according to claim 23, wherein the test information of the examinee further includes information on total usage time taken in inputting answers for all questions by the examinee.

26. The test analyzing method according to claim 23, wherein the test information of the examinee further includes information on a question sequence of selecting the answer inputs by the examinee.

27. The test analyzing method according to claim 23,
wherein a test sheet or an answer sheet provided for the examinee equipment includes a try-again input box to be checked by the examinee to input an answer of a corresponding question again, or a try-later input box to be checked by the examinee to input an answer of a corresponding question later, and
wherein the test information of the examinee further includes information on whether the try-again input box or the try-later input box is checked with respect to the corresponding question.

28. The test analyzing method according to claim 27, wherein the question-specific time includes a time from time of inputting an answer of a previous question to time of checking the try-again input box or the try-later input box.
